(19) United States
(12) Patent Application Publication
(10) Pub. No.: US 2017/0187023 A1
(43) Pub. Date: Jun. 29, 2017

(54) NONAQUEOUS ELECTROLYTE SECONDARY BATTERY SEPARATOR

(71) Applicant: Sumitomo Chemical Company, Limited, Tokyo (JP)

(72) Inventors: Akinobu SAKAMOTO, Niihama-shi (JP); Takuya AKIYAMA, Niihama-shi (JP)

(21) Appl. No.: 15/388,570

(22) Filed: Dec. 22, 2016

(30) Foreign Application Priority Data
Dec. 24, 2015 (JP) 2015-252425

(51) Int. Cl. H01M 2/16

(52) U.S. Cl. CPC H01M 2/1653; H01M 2/1686; H01M 2/1673

(57) ABSTRACT

The present invention provides a nonaqueous electrolyte secondary battery separator that achieves an excellent rate characteristic by having a tensile creep compliance J satisfying at least one of the following three conditions in a case where stress of 30 MPa is applied for t seconds:

(i) when t=300 seconds, J=4.5 GPa⁻¹ to 14.0 GPa⁻¹,

(ii) when t=1800 seconds, J=9.0 GPa⁻¹ to 25.0 GPa⁻¹,

(iii) when t=600 seconds, J=12.0 GPa⁻⁵ to 32.0 GPa⁻¹.

This Nonprovisional application claims priority under 35 U.S.C. §119 on Patent Application No. 2015-252425 filed in Japan on Dec. 24, 2015, the entire contents of which are hereby incorporated by reference.

### TECHNICAL FIELD

The present invention relates to (i) a separator for a nonaqueous electrolyte secondary battery (hereinafter referred to as a “nonaqueous electrolyte secondary battery separator”) made up of a porous film and (ii) a laminated separator for a nonaqueous electrolyte secondary battery” (hereinafter referred to as a “nonaqueous electrolyte secondary battery laminated separator”) in which a porous layer is laminated on the porous film.

### BACKGROUND ART

Nonaqueous electrolyte secondary batteries, in particular, lithium ion secondary batteries have a high energy density, and are thus in wide use as batteries for a personal computer, a mobile telephone, a portable information terminal, and the like. Such nonaqueous electrolyte secondary batteries have recently been developed as an on-vehicle battery.

In the lithium ion secondary battery, charge and discharge occur by insertion and de sorption of lithium ions in a crystal lattice of an electrode active substance. The insertion and desorption of lithium ions cause expansion and contraction of the electrode active substance and an electrode which includes the electrode active substance.

Recent nonaqueous electrolyte secondary batteries, in particular, recent lithium ion secondary batteries are becoming smaller and thinner. In accordance with the circumstances, wall thicknesses of battery containers are becoming smaller and the battery containers are becoming softer. Accordingly, the expansion and contraction of the electrode may cause deformation of the battery container, i.e., a battery. With regard to the problem, in order to prevent the deformation, a nonaqueous electrolyte secondary battery has been proposed which includes a separator having a certain range of tensile creep amount (Patent Literature 1).

Moreover, recent nonaqueous electrolyte secondary batteries are demanded to enable faster charge and discharge. However, in a case where charge and discharge are carried out fast, a high load of stress is applied to the separator inside the battery in a short time due to expansion and contraction of the electrode caused by the charge and discharge. This may apply a specific amount of stress to the separator, and a rate characteristic or the like of the battery may decrease.

### CITATION LIST

### [Patent Literature]

[Patent Literature 1]

Japanese Patent Application Publication Tokukai No. 2002-358944 (Publication date: Dec. 13, 2002)

### SUMMARY OF INVENTION

### Technical Problem

Recently, therefore, a nonaqueous electrolyte secondary battery separator is demanded from which a nonaqueous electrolyte secondary battery which can be charged and discharged fast and is excellent in battery characteristic (rate characteristic) in a case where fast discharge is carried out.

However, the tensile creep amount defined in Patent Literature 1 corresponds to a case where a low load (10 g) of stress is applied for a long time (2 hours), and does not correspond to a case where a high load of stress is applied for a short time.

### Solution to Problem

The inventors of the present invention have found the followings: that is, a nonaqueous electrolyte secondary battery having an excellent rate characteristic can be obtained in a case where the nonaqueous electrolyte secondary battery includes, as a separator or a separator base material, a porous film which has a tensile creep compliance that falls within a specific range with respect to a high load of stress for a specific time corresponding to short-time charge and discharge. Based on this finding, the inventors of the present invention have accomplished the present invention.

The present invention can include a nonaqueous electrolyte secondary battery separator, a nonaqueous electrolyte secondary battery laminated separator, a member for a nonaqueous electrolyte secondary battery (hereinafter referred to as a “nonaqueous electrolyte secondary battery member”), and a nonaqueous electrolyte secondary battery which are described below.

The nonaqueous electrolyte secondary battery separator in accordance with an aspect of the present invention is made up of a porous film containing a polyolefin resin as a main component.

The porous film having a tensile creep compliance J that satisfies at least one of conditions (i) through (ii) below in a case where stress of 30 MPa is applied for t seconds in a transverse direction:

(i) when t=300 seconds, J is 4.5 GPa⁻¹ or more and 14.0 GPa⁻¹ or less,

(ii) when t=1800 seconds, J is 9.0 GPa⁻¹ or more and 25.0 GPa⁻¹ or less,

(iii) when t=3600 seconds, J is 12.0 GPa⁻¹ or more and 32.0 GPa⁻¹

or less.

The nonaqueous electrolyte secondary battery separator in accordance with an aspect of the present invention preferably satisfies all the conditions (i) through (iii).

The nonaqueous electrolyte secondary battery laminated separator in accordance with an aspect of the present invention includes the nonaqueous electrolyte secondary battery separator of the present invention and a porous layer which is laminated on at least one surface of the nonaqueous electrolyte secondary battery separator.

The nonaqueous electrolyte secondary battery member in accordance with an aspect of the present invention includes a cathode, the nonaqueous electrolyte secondary battery separator of the present invention or the nonaqueous electrolyte secondary battery laminated separator of the present invention, and an anode which are arranged in this order.

The nonaqueous electrolyte secondary battery in accordance with an aspect of the present invention includes the nonaqueous electrolyte secondary battery separator of the present invention or the nonaqueous electrolyte secondary battery laminated separator of the present invention.

Advantageous Effects of invention

The nonaqueous electrolyte secondary battery separator of the present invention allows a nonaqueous electrolyte secondary battery, which includes the nonaqueous electrolyte secondary battery separator, to have an excellent rate characteristic.

### BRIEF DESCRIPTION OF DRAWINGS

FIG. 1 is a view showing a relation between a rate characteristic (%) and a value of (porosity/thickness) of each of porous films produced in Examples and Comparative Examples.

### DESCRIPTION OF EMBODIMENTS

The following description will discuss an embodiment of the present invention in detail. Note that, in the present application, “A to B” means “A or more (higher) and B or less (lower)”.

### Embodiment 1

### Nonaqueous Electrolyte Secondary Battery Separator

### Embodiment 2

### Nonaqueous Electrolyte Secondary Battery Laminated Separator

The nonaqueous electrolyte secondary battery separator in accordance with Embodiment 1 of the present invention is a nonaqueous electrolyte secondary battery separator which is made up of a porous film containing a poly olefin resin as a main component, the porous film having a tensile creep compliance J that satisfies at least one of conditions (i) through (iii) below in a case where stress of 30 MPa is applied for t seconds in a transverse direction;

(i) when t=300 seconds, J is 4.5 GPa⁻¹ or more and 14.0 GPa⁻¹ or less,

(ii) when t=1800 seconds, J is 9.0 GPa⁻¹ or more and 25.0 GPa⁻¹ or less,

(iii) when t=3600 seconds, J is 12.0 GPa⁻¹ or more and 32.0 GPa⁻¹;

or less.

The nonaqueous electrolyte secondary battery laminated separator in accordance with Embodiment 2 of the present invention includes the nonaqueous electrolyte secondary battery separator (porous film) in accordance with Embodiment 1 of the present invention and a porous layer which is laminated on at least one surface of the nonaqueous electrolyte secondary battery separator.

### <Porous Film>

The porous film in accordance with an aspect of the present invention can be a nonaqueous electrolyte secondary battery separator or a base material of a nonaqueous electrolyte secondary battery laminated separator which will be described later. The porous film contains polyolefin as a main component and has a large number of pores which are connected to one another and penetrate the porous film so that gas or liquid can pass through the porous film from one side surface to the other side surface. The porous film can be made up of one layer or can be made up of a plurality of laminated layers.

The description “contains a polyolefin resin as a main component” means that a ratio of the polyolefin resin accounting for the porous film is 50 volume % or more, preferably 90 volume % or more, more preferably 95 volume % or more, relative to the entire porous film. It is more preferable that the polyolefin resin contains a polymeric component whose weight-average molecular weight is 5×10⁵ to 15×10⁶. In particular, in a case where the polyolefin contains a polymeric component whose weight-average molecular weight is 1 million or more, strength of a nonaqueous electrolyte secondary battery separator which is the porous film and strength of a nonaqueous electrolyte secondary battery laminated separator which is a laminated body including the porous film are advantageously improved.

The polyolefin resin which is the main component of the porous film is not limited to a particular one, and examples of the polyolefin resin encompass thermoplastic resins such as a homopolymer (e.g., polyethylene, polypropylene, poly butane) and a copolymer (e.g., ethylene-propylene copolymer) which are obtained by (co)polymerizing monomers such as ethylene, propylene, 1-butene, 4-methyl-1-pentene, and 1-hexene. Among these, polyethylene is more preferable because it is possible to prevent (shut down) a flow of overcurrent at a lower temperature. Examples of the polyethylene encompass low-density polyethylene, high-density polyethylene, linear polyethylene (ethylene-α-oleffn copolymer), ultra-high molecular weight polyethylene whose weight-average molecular weight, is 1 million or more, and the like. Among these, ultra-high molecular weight polyethylene whose weight-average molecular weight is 1 million or more is further preferable.

In a case, where the nonaqueous electrolyte secondary battery separator is made up of only the porous film, a film thickness of the porous film is preferably 4 μm to 40 μm, more preferably 5 μm to 30 μm, and further preferably 6 μm to 15 μm, in a case where the nonaqueous electrolyte secondary battery laminated separator (laminated body) is formed by using the porous film as a base material and laminating a porous layer on one surface or both surfaces of the porous film, a film thickness of the porous film, can be appropriately determined in consideration of a film thickness of the laminated body, and the film thickness of the porous film is preferably 4 μm to 40 μm, and more preferably 5 μm to 20 μm.

The film thickness of the porous film is preferably 4 μm or more in the nonaqueous electrolyte secondary battery which includes the nonaqueous electrolyte secondary battery separator or the nonaqueous electrolyte secondary battery laminated separator in which the porous film is used because it is possible to sufficiently prevent internal short-circuit due to damage of the battery or the like. Meanwhile, the film thickness of the porous film is preferably 40 μm or less because of the following reasons: that is, (i) it is possible to restrict increase in lithium ion permeation resistance in the entire nonaqueous electrolyte secondary battery separator or the entire nonaqueous electrolyte secondary battery laminated separator in which the porous film is used, (ii) it is possible, in the nonaqueous electrolyte secondary battery including the separator, to prevent deterioration of the cathode and decrease in rate characteristic and cycle characteristic due to repetition of charge-discharge cycles, and (iii) it is possible to prevent enlargement in size of the nonaqueous electrolyte secondary battery itself clue to increase in distance between the cathode and the anode.

A weight per unit area of the porous film can be determined as appropriate by taking into consideration strength, a film thickness, a weight, and handleabllity of the nonaqueous electrolyte secondary battery separator or the nonaqueous electrolyte secondary battery laminated separator which includes the porous film. Specifically, the weight, per unit area of the porous film is typically preferably 4 g/m² to 20 g/m², more preferably 5 g/m² to 12 g/m² so that higher weight energy density and volume energy density of the battery, which includes the nonaqueous electrolyte secondary battery separator or the nonaqueous electrolyte secondary battery laminated separator, can be achieved.

Air permeability of the porous film is preferably, as a Gurley value, 30 sec/100 ml to 500 sec/100 ml, more preferably 50 sec/100 ml to 300 sec/100 mL. In a case where the porous film has the above air permeability, the nonaqueous electrolyte secondary battery separator or the nonaqueous electrolyte secondary battery laminated separator which, includes the porous film can obtain sufficient ion permeability.

A porosity of the porous film is preferably 20 volume % to 80 volume %, more preferably 30 volume % to 75 volume % in order to enhance a retained amount of an electrolyte and to obtain a function to surely prevent (shut down) a flow of overcurrent at a lower temperature.

In order to obtain the porous film in accordance with an aspect of the present invention which has the “tensile creep compliance” failing within a suitable range described later, the porosity of the porous film is preferably 40 volume % to 75 volume %, and more preferably 50 volume % to 75 volume %.

In a case where the porosity of the porous film is less than 20 volume %, resistance of the porous film increases. In a case where the porosity of the porous film is more than 80 volume %, mechanical strength of the porous film decreases. In a case where the porosity of the porous film is 40 volume % or more, a ratio of a resin, which accounts for an area of the porous film to which area stress is applied, becomes lower, and therefore the porous film is more likely to be stretched. The porosity of the porous film is preferably 75 volume % or lower in order to maintain the mechanical strength of the porous film.

A pore diameter of each of pores in the porous film is preferably 0.3 μm or less, and more preferably 0.14 μm or less so that the nonaqueous electrolyte secondary battery separator or the nonaqueous electrolyte secondary battery laminated separator which includes the porous film can obtain sufficient ion permeability and prevent particles from entering the cathode and the anode.

In this specification, the “tensile creep compliance” means a reciprocal number of “tensile creep elastic modulus” measured based on JIS K 7115 under conditions in which a temperature is 23° C., a relative humidity is 50%, and a stress applied to the porous film in a transverse direction is 30 MPa. A unit of the tensile creep compliance is GPa⁻¹, and the tensile creep compliance is obtained by dividing a strain (creep amount) in a specific time (t) by the stress. Moreover, the “tensile creep compliance” is an indicator indicative of stretchability of the porous film with respect to external force. That is, a porous film whose “tensile creep compliance” is high Is a porous film which stretches (deforms) in accordance with an applied external stress, and thus an internal structure of the porous film is less likely to be damaged.

The porous film in accordance with an aspect of the present invention has the “tensile creep compliance” J which satisfies at least one of conditions (i) through (iii) below, and preferably satisfies all the conditions (i) through (iii) below:

(i) when t=300 seconds, J is 4.5 GPa⁻¹ or more and 14.0 GPa⁻¹ or less,

(ii) when t=1800 seconds, J is 9.0 GPa⁻¹ or more and 25.0 GPa⁻¹ or less,

(iii) when t=3600 seconds, J is 12.0 GPa⁻¹ or more and 32.0 GPa⁻¹ or less.

In the lithium ion secondary battery, tensile stress in the transverse direction is applied to the separator in accordance with charging, and a magnitude of the tensile stress is typically approximately 20 MPa to 200 MPa, and preferably 30 MPa. That is, the tensile creep compliance defined in this specification of the present application is an indicator indicative of stretch ability of the porous film with respect to stress that is substantially identical with stress applied to the porous film in a case where the porous film is used as a separator or a separator base material in a nonaqueous electrolyte secondary battery.

The time t=300 seconds corresponds to a case where the nonaqueous electrolyte secondary battery which includes the porous film as a separator or a separator base material is charged and discharged in 300 seconds=5 minutes. In a case where t=300 seconds, J is 4.5 GPa⁻¹ or more and 14.0 GPa⁻¹ or less, preferably 4.5 GPa⁻¹ or more and 12.0 GPa⁻or less, and more preferably 5.0 GPa⁻¹ or more and 11.0 GPa⁻¹ or less.

Similarly, the times t=1800 seconds and t=3600 seconds correspond to respective cases where the nonaqueous electrolyte secondary battery which includes the porous film as a separator or a separator base material is charged and discharged in 1800 seconds=30 minutes and 3600 seconds=1 hour. In a case where t=1800 seconds, J is 9.0 GPa⁻¹ or more and 25.0 GPa⁻¹ or less, preferably 9.0 GPa⁻¹ or more and 22.0 GPa⁻¹ or less, and more preferably 10.0 GPa⁻¹ or more and 20.0 GPa⁻¹ or less. In a case where t=3600 seconds, d is 12.0 GPa⁻¹ or more and 32.0 GPa⁻¹ or less, preferably 12.0 GPa⁻¹ or more and 28,0 GPa⁻¹ or less, and more preferably 13.0 GPa⁻¹ or more and 26.0 GPa⁻¹ or less.

Therefore, in a case where the value J is smaller than the above range, in the nonaqueous electrolyte secondary battery which includes the porous film as a separator or a separator base material, the separator cannot adapt to expansion and contraction (volume change) of the electrode due to charge and discharge in the corresponding time, and the separator is partially damaged. This may cause decrease in rate characteristic of the nonaqueous electrolyte secondary battery. Meanwhile, in a case where the value J is larger than the above range, in the nonaqueous electrolyte secondary battery which includes the porous film as a separator or a separator base material, the porous film is greatly stretched in accordance with volume change of the electrode, and the porous film itself becomes excessively thin and therefore mechanical strength of the separator decreases. That is, the nonaqueous electrolyte secondary battery which includes the porous film satisfying the condition (i) as a separator or a separator base material is excellent in rate characteristic especially in a case of 5-minutes charge and discharge, the nonaqueous electrolyte secondary battery which includes the porous film satisfying the condition (ii) as a separator or a separator base material is excellent in rate characteristic especially in a case of 30-minutes charge and discharge, and the nonaqueous electrolyte secondary battery which includes the porous film satisfying the condition (iii) as a separator or a separator base material is excellent in rate characteristic especially in a case of 1-hour charge and discharge.

That is, the nonaqueous electrolyte secondary battery separator in accordance with an aspect of the present invention includes the porous film whose tensile creep compliance falls within the specific range, and the porous film can appropriately adapt to volume change of the electrode due to charge and discharge of the nonaqueous electrolyte secondary battery which includes the porous film as a nonaqueous electrolyte secondary battery separator. This is considered as a reason that the nonaqueous electrolyte secondary battery has an excellent rate characteristic.

Moreover, the tensile creep compliance J(t) generally increases as time passes, and therefore, in the porous film which satisfies all the conditions (i) through (iii), typically, a lower limit of J(t) is 4.5 GPa⁻¹ to 12.0 GPa⁻¹, and an upper limit of J(t) is 14.0 GPa⁻¹ to 32.0 GPa⁻¹, in the range of t=300 seconds to t=3600 seconds. Therefore, the nonaqueous electrolyte secondary battery which includes the porous film satisfying all the three conditions as a separator or a separator base material is more excellent in rate characteristic because, typically, decrease in rate characteristic is restricted in a case of charge and discharge in a short time, i.e., 5 minutes to 1 hour.

A method for controlling the tensile creep compliance can be (a) a method in which, in the porous film production method described later, a molecular weight, an aspect, and the like of a polyolefin resin that is a raw material of the porous film are adjusted; (b) a method in which the porosity of the porous film is adjusted to the above described range; or the like.

Moreover, it is possible to provide, on the porous film, a publicly known porous layer such as an adhesive layer, a heat-resistant layer, and/or a protective layer. In the present specification, a separator including (i) a nonaqueous electrolyte secondary battery separator and (ii) a porous layer is referred to as “nonaqueous electrolyte secondary battery laminated separator” (hereinafter, sometimes referred to as “laminated separator”), in a case where the porous layer is formed on the porous film, that is, in a ease where the nonaqueous electrolyte secondary battery laminated separator is produced, the porous film is more preferably subjected to hydrophilizing treatment before the porous layer is formed, i.e., before a coating liquid (later described) is applied. In a case where the porous film is subjected to the hydrophilizing treatment, coatability of the coating liquid is further improved, and it is therefore possible to form a further uniform porous layer. The hydrophilizing treatment is effective for a case where a high ratio of water accounts for a solvent (dispersion medium) which is contained in the coating liquid. Specifically, examples of the hydrophilizing treatment encompass publicly known treatments such as chemical treatment by acid or alkali, etc., corona treatment, and plasma treatment. Among the above hydrophilizing treatments, the corona treatment is more preferable because the porous film can foe hydrophilized in a relatively short time and only the vicinity of a surface of the porous film is hydrophilized, i.e., inside quality of the porous film is not changed.

### [Method for Producing Porous Film]

A method for producing the porous film is not limited to a particular one and can be, for example, a method in which a pore forming agent is added to a resin such as polyolefin, then the resin is shaped into a film (filmy shape), and then the pore forming agent is removed by an appropriate solvent.

Specifically, for example, in a case where a porous film is produced with use of a polyolefin resin containing ultra-high molecular weight polyethylene and low molecular weight, polyolefin whose weight-average molecular weight is 10 thousand or less, it is preferable to produce the porous film with a method described below from the viewpoint of production cost:
(1) a step of obtaining a polyolefin resin composition by kneading 100 parts by weight of ultra-high molecular weight polyethylene, 5 parts by weight to 200 parts by weight, of low molecular weight polyolefin whose weight-average molecular weight is 10 thousand or less, and 100 parts by weight to 400 parts by weight of a pore forming agent;

(2) a step of forming a rolled sheet by rolling the polyolefin resin composition;

then,
(3) a step of removing the pore forming agent from the rolled sheet obtained in the step (2);
(4) a step of stretching the sheet from which the pore forming agent has been removed in the step (3);
(5) a step of obtaining a porous film by carrying out, with respect, to the sheet which has been stretched in the step (4). heat fixation at a heat fixation temperature of 100° C. or higher and 150° C. or lower.

Alternatively,
(3′) a step of stretching the rolled sheet, which has been obtained in the step (2);
(4′) a step of removing the pore forming agent from the sheet which has been stretched in the step (3′);
(5′) a step of obtaining a porous film by carrying out, with respect to the sheet which has been obtained in the step (4′), heat fixation at a heat fixation temperature of 100° C. or higher and 150° C. or lower.

The pore forming agent can be an inorganic filler, a plasticizer, or the like.

The inorganic filler is not limited to a particular one and can be an inorganic filler or the like which can be dissolved in any of a water-based solvent containing acid, a water-based solvent containing alkali, a water-based solvent mainly composed of water. Examples of the inorganic filler which can be dissolved in a water-based solvent containing acid encompass calcium carbonate, magnesium carbonate, barium carbonate, zinc oxide, calcium oxide, aluminum hydroxide, magnesium hydroxide, calcium hydroxide, calcium sulfate, and the like. Calcium carbonate is preferable because fine powder is easily obtained at a low cost. Examples of the inorganic filler which can be dissolved in a water-based solvent, containing alkali encompass silicic acid, zinc oxide, and the like. Silicic acid is preferable because fine powder is easily obtained at a low cost, Examples of the inorganic filler which can be dissolved in a water-based solvent mainly composed of water encompass calcium chloride, sodium chloride, magnesium sulfate, and the like.

The plasticisser is not limited to a particular one, and can be low molecular weight hydrocarbon such as liquid paraffin.

A weight-average molecular weight of whole polymers constituting a resin used in production of the porous film is preferably 1 million or less, and more preferably 800 thousand or less in a resin composition obtained in the step (1), The weight-average molecular weight is preferably 1 million or less because polymers in the porous film are less entangled with each other and therefore the porous film is more likely to be stretched (i.e., more likely to creep). Moreover, the resin polymers constituting the porous film can be a linear chain type or a branched chain type, and is preferably a linear chain type in order to reduce entanglement of polymers.

An indicator that can be simply measured instead of the molecular weight can be a melt flow rate (MFR). The melt flow rate (MFR) can be adjusted by adjusting operation conditions (e.g., screw rotation speed, temperature, and the like) of the kneader used in the step (1). Even in a case where raw materials of the polyolefin resin which are put into the kneader are identical, a melt flow rate (MFR) of a resultant resin composition varies depending on the operation conditions, and the operation conditions also influence the “tensile creep compliance” in the present invention.

A melt flow rate (MFR) of the resin composition obtained in the step (1) is preferably 20 g/10 min or more, more preferably 30 g/10 min or more, and further preferably 32 g/10 min or more. Moreover, the melt flow rate is preferably 50 g/10 min or less.

The melt flow rate is measured with the following method:
Measurement standard: JIS K 7120-1
Measurement conditions:
   Orifice: diameter of 3 mm×length of 10 mm
   Measurement temperature: 240° C.
   Load: 21.6 kg.

Further, a method for adjusting porosity of an obtained porous film can be a method in which a used amount of the pore forming agent is adjusted. The used amount of the pore forming agent is preferably 1.00 parts by weight to 300 parts by weight, and more preferably 100 parts by weight to 200 parts by weight, relative to 100 parts by weight of a resin contained in the porous film.

Furthermore, a heat fixation temperature in the step (5) is preferably 100° C. or higher and 140° C. or lower, and more preferably 105° C. or higher and 120° C. or lower. In a ease where the heat fixation temperature is higher than 140° C., pores in the porous film may be squashed and blocked.

### [Porous Layer]

The porous layer in accordance with, an aspect of the present invention can contain fine particles and is typically a resin layer containing a resin. The porous layer in accordance with an aspect of the present invention is preferably a heat-resistant layer or an adhesive layer that is laminated on one surface or each of both surfaces of the porous film. The resin constituting the porous layer is preferably insoluble in a battery electrolyte and is electrochemically stable within a used range of the battery. In a case where the porous layer is laminated on one surface of the porous film, the porous layer is preferably laminated on a surface of the porous film which surface faces the cathode in the nonaqueous electrolyte secondary battery, and is more preferably laminated so as to make contact with the cathode.

Concrete examples of the resin encompass: polyolefins such as polyethylene, polypropylene, polybutene, and ethylene-propylene copolymers; fluorine-containing resins such as polyvinylidene fluoride (PVDF) and polytetrafluoroethylene; fluorine-containing rubbers such as vinylidene fluoride-hexafluoropropylene copolymers, tetrafluoroethylene-hexafluoropropylene copolymers, tetrafluoroethylene-perfluoroalkyl vinyl ether copolymers, vinylidene fluoride-tetrafluoroethylene copolymers, vinylidene fluoride-trifluoroethylene copolymers, vinylidene fluoride-trichloroethylene copolymers, vinylidene fluoride-vinyl fluoride copolymers, vinylidene fluoride-hexafluoropropylene-tetrafluoroethylene copolymers, and ethylene-tetrafluoroethylene copolymers; aromatic polyamides; wholly aromatic polyamides (aramid resins); rubbers such as styrene-butadiene copolymers and hydrides thereof, methacrylic acid ester copolymers, acrylonitrile-acrylic acid ester copolymers, styrene-acrylic acid ester copolymers, ethylene propylene rubber, and polyvinyl acetate; resins whose melting point or glass transition temperature is 180° C. or higher, such as polyphenylene ether, polysulfone, polyether sulfone, polyphenylene sulfide, polyetherimide, polyamide imide, polyetheramide, and polyester; water-soluble polymers such as polyvinyl alcohol, polyethylene glycol, cellulose ether, sodium alginate, polyacrylic acid, polyacrylamide, and polymethacrylic acid; and the like.

Further, concrete examples of the aromatic polyamide encompass: poly (paraphenylene terephthalamide), poly(metaphenylene isophthalamide), poly (parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, a metaphenylene terephthalamide/2,6-dichloroparaphenylene terephthalamide copolymer, and the like. The aromatic polyamide is more preferably poly (paraphenylene terephthalamide) among the above examples.

The resin is more preferably any of the polyolefins, the fluorine-containing resins, the aromatic polyamides, and the water-soluble polymers among the above examples of the resin. In a case where the porous layer is arranged so as to face the cathode, among those, the resin is further preferably the fluorine-containing resins or the fluorine-containing rubbers, and particularly preferably the polyvinyildene fluoride resin (homopolymer of vinylidene fluoride (i.e., polyvinylidene fluoride), a copolymer of vinylidene fluoride, hexafluoropropylene, tetrafluoroethylene, trifiuoroethylene, trichioroethylene, vinyl fluoride, and the like) because such resins make it easy to maintain properties such as a rate characteristic and a resistance characteristic (solution resistance) of the nonaqueous electrolyte secondary battery due to acidic deterioration during operation of the battery. Further, the resin is more preferably any of the water-soluble polymers in view of processes and environmental load, because in the case of the water-soluble polymers, water can be used as a solvent for forming a porous layer. The water-soluble polymer is further preferably cellulose ether or sodium alginate, and particularly preferably cellulose ether.

Concrete examples of the cellulose ether encompass: carboxymethyl cellulose (CMC), hydroxyethyl cellulose (HEC), carboxyethyl cellulose, methyl cellulose, ethyl cellulose, cyanoethyl cellulose, oxyethyl cellulose, and the like. The cellulose ether is more preferably CMC or HEC and particularly preferably CMC, because CMC and HEC less degrade in use over a long term and are excellent in chemical stability.

In this specification, the fine particles are organic fine particles or inorganic fine particles which are generally called a filler. Therefore, the resin is to serve as a binder resin for bonding fine particles together and bonding the fine particles to the porous film. The fine particles are preferably electrically insulating fine particles.

Concrete examples of the organic fine particles contained in the porous layer in accordance with an aspect of the present invention encompass (i) homopolymers of monomers such as styrene, vinyl ketone, acrylonitrile, methyl methacrylate, ethyl methacrylate, glycidyl methacrylate, glycidyl acrylate., methyl acrylate, or the like, or (ii) copolymers of two or more kinds of monomers such as styrene, vinyl ketone, acrylonitrile, methyl methacrylate, ethyl methacrylate, glycidyl methacrylate, glycidyl acrylate, methyl acrylate, and the like; fluorine-containing resins such as polytetrafluoroethylene, tetrafluoroethylene-hexafluoropropylene copolymers, tetrafluoroethylene-ethylene copolymers, and polyvinylidene fluoride; melamine resin; urea resin; polyethylene; polypropylene; polyacrylic acid, polymethacrylic acid; and the like. These organic fine particles are electrically insulating fine particles.

Concrete examples of the inorganic fine particles contained in the porous layer in accordance with an aspect of the present invention encompass fillers made of an inorganic matter such as calcium carbonate, talc, clay, kaolin, silica, hydrotalcite, diatomite, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, glass, and the like. These inorganic fine particles are electrically insulating fine particles. The fillers can be used alone or in combination of two or more kinds.

The fillers made of an inorganic matter are suitable as the filler. The filler is more preferably a filler made of inorganic oxide such as silica, calcium oxide, magnesium oxide, titanium oxide, alumina, mica, zeolite, aluminum hydroxide, or boehmite, further preferably at least one kind of filler selected from among a group consisting of silica, magnesium oxide, titanium oxide, aluminum hydroxide, boehmite, and alumina, and particularly preferably alumina. There are various crystal forms of alumina, such as α-alumina, β-alumina, γ-alumina, θ-alumina, etc. It is possible to suitably use alumina of any form. Among the various forms of alumina, α-alumina is the most preferable because α-alumina has a particularly high thermal stability and a particularly high chemical stability.

A shape of the filler varies depending on a method for producing a raw material, i.e., an organic substance or an inorganic substance, a dispersion condition of the filler when a coating liquid for forming the porous layer is prepared, and the like. The shape of the filler can be any of various shapes including (i) a shape such as a spherical shape, an oval shape, a rectangular shape, a gourd-like shape and (ii) an indefinite shape having no specific shape.

In a case where the porous layer contains a filler, a filler content is preferably 1 volume % to 99 volume %, more preferably 5 volume % to 95 volume %, relative to the porous layer. In a case where the filler content is within the above range, gaps formed by contacts of particles of the filler are less likely to be blocked by a resin and the like, and it is therefore possible to obtain a sufficient ion permeability and an appropriate weight per unit area.

The fine particles can be two or more types of fine particles which types are different in particle diameter and/or in specific surface area.

An amount of the fine particles contained in the porous layer is preferably 1 volume % to 99 volume %, more preferably 5 volume % to 95 volume %, relative to the porous layer. In a case where the contained amount of the fine particles falls within the above range, gaps which are formed due to contacts of the fine particles are less likely to be blocked by a resin and the like, and it is therefore possible to obtain sufficient ion permeability and an appropriate weight per unit area.

A film thickness of the porous layer in accordance with an aspect of the present invention can be determined as appropriate by taking into consideration a film thickness of the laminated body which is the nonaqueous electrolyte secondary battery laminated separator. In a case where the laminated body is formed by laminating a porous layer on one surface or both surfaces of the porous film that is used as a base material, the film thickness of the porous layer is preferably 0.5 μm to 15 μm (per one surface), and more preferably 2 μm to 10 μm (per one surface).

In a case where the film thickness of the porous layer is less than 1 μm and the laminated body is used as the nonaqueous electrolyte secondary battery laminated separator, it is impossible to sufficiently prevent internal short-circuit due to damage of the battery or the like. Moreover, a retained amount, of the electrolyte in the porous layer decreases. Meanwhile, in a case where a total film thickness of the porous layers on both surfaces exceeds 30 μm and the laminated body is used as the nonaqueous electrolyte secondary battery laminated separator, lithium ion permeation resistance in the entire separator increases, and therefore repetition of cycles leads to deterioration of the cathode, and accordingly a rate characteristic and a cycle characteristic decrease. Moreover, a distance between the cathode and the anode increases, and therefore the nonaqueous electrolyte secondary battery is enlarged in size.

In the descriptions below relating to physical properties of the porous layer, in a case where the porous layers are laminated on both surfaces of the porous film, at least physical properties of the porous layer which is laminated on a surface of the porous film which surface faces the cathode in the nonaqueous electrolyte secondary battery are indicated.

A weight per unit area (per one surface) of the porous layer can be determined as appropriate by taking into consideration strength, a film thickness, a weight, and handleability of the laminated body. Typically, the weight per unit area is preferably 1 g/m² to 20 g/m², and more preferably 2 g/m² to 10 g/m² so that, in a case where the laminated body is used as the nonaqueous electrolyte secondary battery laminated separator, a weight energy density and a volume energy density of the battery can foe enhanced. In a case where the weight per unit area of the porous layer is greater than the above range and the laminated body is used as the nonaqueous electrolyte secondary battery laminated separator, the nonaqueous electrolyte secondary battery becomes heavier.

The porosity of the porous layer is preferably 20 volume % to 90 volume %, and more preferably 30 volume % to 80volume % so that sufficient ion permeability can be obtained. A pore diameter of pores provided in the porous layer is preferably 3 μm or less, more preferably 1 μm or less, and further preferably 0.5 μm or less so that the porous layer and the nonaqueous electrolyte secondary battery laminated separator including the porous layer can obtain sufficient ion permeability.

### [Laminated Body]

The laminated body which is the nonaqueous electrolyte secondary battery laminated separator in accordance with an aspect of the present invention has the configuration in which the porous layer is laminated on one surface or both surfaces of the porous film.

A film thickness of the laminated body in accordance with an aspect of the present invention is preferably 5.5 μm to 45 μm, and more preferably 6 μm to 25 μm.

Air permeability of the laminated body in accordance with an aspect of the present invention is, in terms of Gurley value, preferably 30 sec/100 mL to 1000 sec/100 ml, more preferably 50 sec/100 mL to 800 sec/100 ml, in a case where the laminated body having the above air permeability is used as the nonaqueous electrolyte secondary battery laminated separator, it is possible to obtain sufficient ion permeability. In a case where the air permeability is greater than the above range, this means that the porosity of the laminated body is high and the lamination structure is rough. This leads to decrease in strength of the laminated body, and therefore shape stability particularly at a high temperature may become insufficient. Meanwhile, in a case where the laminated body having air permeability less than the above range is used as the nonaqueous electrolyte secondary battery laminated separator, sufficient ion permeability cannot be obtained, and a battery characteristic of the nonaqueous electrolyte secondary battery may decrease.

Note that the laminated body in accordance with an aspect; of the present invention can include, according to need, publicly known porous films such as a heat-resistant layer, an adhesive layer, and a protective layer in addition to the porous film and the porous layer, to an extent that does not impair the purpose of the present invention.

The laminated body in accordance with an aspect of the present invention includes, as a base material, the porous film whose tensile creep compliance falls within the specific range. Therefore, the laminated body can appropriately adapt to volume change of the electrode due to charge and discharge of the nonaqueous electrolyte secondary battery which includes the laminated body as a nonaqueous electrolyte secondary battery laminated separator. As a result, the nonaqueous electrolyte secondary battery has an excellent rate characteristic.

### [Method for Producing Porous Layer and Laminated Body]

A method for producing a porous layer and a laminated body in accordance with an aspect of the present invention can be a method in which a coating liquid described later is applied to a surface of the porous film, and a porous layer is deposited by drying the coating liquid.

The coating liquid that is used in the method for producing the porous layer in accordance with an aspect of the present invention can be typically prepared by (i) dissolving a resin that is contained in the porous layer of the present invention in a solvent and (ii) dispersing fine particles contained in the porous layer of the present invention.

The solvent (dispersion medium) is not limited to a particular one, provided that the solvent (i) does not adversely influence the porous film, (ii) dissolves the resin uniformly and stably, and (iii) disperses the fine particles uniformly and stably. Concrete examples of the solvent (dispersion medium) encompass water; lower alcohol such as methyl alcohol, ethyl alcohol, n-propyl alcohol, isopropyl alcohol, t-butyl alcohol and the like; acetone, toluene, xylene, hexane, N-methylpyrrolid one, N, N-dimethyl acetamide, N,N-dimethyl formamide and the like. The solvent (dispersion medium) can be used alone or in combination of two or more of these.

The coating liquid can be prepared by any method, provided that conditions (such as a resin, solid content (resin concentration) and a fine particle amount) necessary for obtaining an intended porous layer are satisfied. Concrete examples of the method for preparing the coating liquid encompass a mechanical stirring method, an ultrasonic dispersion method, a high-pressure dispersion method, a medium dispersion method, and the like. The fine particles can be dispersed in the solvent (dispersion medium) by the use of a conventionally known dispersing device such as a three-one motor, a homogenisser, a medium type dispersing device, a pressure type dispersing device or the like. Further, a liquid in which the resin is dissolved or swollen or an emulsified liquid of the resin can be supplied to a wet grinding device when wet grinding is carried out in order to obtain fine particles having an intended average particle diameter, and it is thus possible to prepare a coating liquid concurrently with the wet grinding of the fine particles. That is, the wet grinding of the fine particles and the preparation of the coating liquid, can be carried out in a single process. The coating liquid can contain, as a component other than the resin and the fine particles, an additive such as a dispersing agent, a plasticizer, a surfactant, and/or a pH adjuster, as Long as the purpose of the present invention is not impaired. Note that an added amount of the additive can be determined within a range that does not impair the purpose of the present invention.

A method for applying the coating liquid to the porous film is not limited to a particular one. That is, a method for forming a porous layer on a surface of the porous film which has been subjected to hydrophilizing treatment according to need is not limited to a particular one. In a case where the porous layers are laminated on both surfaces of the porous film, it is possible to employ (i) a sequential laminating method in which a porous layer is formed on one surface of the porous film and then another porous layer is formed on the other one surface of the porous film or (ii) a simultaneous laminating method in which porous layers are simultaneously formed on both surfaces of the porous film. Examples of the method for forming the porous layer, that is, the method for producing the laminated body, encompass a method in which a coating liquid Is applied directly on a surface of a porous film and then a solvent (dispersion medium) is removed; a method in which a coating liquid is applied to an appropriate support, a solvent (dispersion medium) is removed so as to form a porous layer, and then the porous layer and a porous film are bonded together by pressure, and then the support is peeled off; a method in which a coating liquid is applied to an appropriate support, then a porous film is bonded, to the coated surface by pressure, then the support is peeled off, and then the solvent (dispersion medium) is removed; a method in which a porous film is soaked in a coating liquid so as to carry out dip coating, and then a solvent (dispersion medium) is removed; and the like. A thickness of the porous layer can be controlled by adjusting a thickness of a coating film which is in a wet state (Wet) after coating, a weight ratio of the resin and the fine particles, a solid content concentration (i.e., a sum of a resin concentration and a fine particle concentration) of the coating liquid, and the like. Note that the support can be, for example, a resin film, a metal belt, a drum, or the like.

The method for applying the coating liquid to the porous film or the support is not limited to a particular one, provided that the method can achieve a necessary weight per unit area and a necessary coating area. The method for coating with the coating liquid can be a conventionally known method. Concrete examples of the coating method encompass a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray coating method, and the like.

The solvent (dispersion medium) is generally removed by a drying method. The drying method can be air drying, air blow drying, drying by heating, drying under reduced pressure, or the like. The drying method can be any of methods, provided that the solvent (dispersion medium) can be sufficiently removed. Alternatively, it is possible to carry out drying after the solvent (dispersion medium) contained in the coating liquid Is substituted by another solvent. The method in which the solvent (dispersion medium) is removed after being substituted by another solvent can be a method in which, for example, with the use of another solvent (hereinafter, referred to as “solvent X”) which is to be dissolved in the solvent, (dispersion medium) contained in the coating liquid and does not dissolve the resin contained in the coating liquid, the porous film or the support which has been coated with the coating liquid is soaked in the solvent X, the solvent (dispersion medium) in the coating film on the porous film or the support is substituted by the solvent X, and then the solvent X is evaporated. According to such a method, it is possible to efficiently remove the solvent (dispersion medium) from the coating liquid. Note that, in a case where the solvent (dispersion medium) or the solvent X is removed, by heating, from the coating film of the coating liquid formed on the porous film or the support, the heating is preferably carried out at a temperature at which an air permeability of the porous film will not be decreased, specifically, at 10° C. to 120° C., more preferably 20° C. to 80° C., in order to avoid a decrease in air permeability caused by shrinkage of pores in the porous film.

The drying can be carried, out with the use of a general dryer.

### Embodiment 3

### Member for Monaqueous Electrolyte Secondary Battery,

### Embodiment 4

### Nonaqueous Electrolyte Secondary Battery

The nonaqueous electrolyte secondary battery member in accordance with Embodiment 3 of the present invention includes a cathode, the nonaqueous electrolyte secondary battery separator in accordance with Embodiment 1 of the present invention or the nonaqueous electrolyte secondary battery laminated separator in accordance with Embodiment 2 of the present invention, and an anode which are arranged in this order. The nonaqueous electrolyte secondary battery in accordance with Embodiment 4 of the present invention includes the nonaqueous electrolyte secondary battery separator in accordance with Embodiment 1 of the present invention or the nonaqueous electrolyte secondary battery laminated separator in accordance with Embodiment 2 of the present invention, and preferably includes the nonaqueous electrolyte secondary battery member in accordance with Embodiment 3 of the present invention. Mote that the nonaqueous electrolyte secondary battery in accordance with Embodiment 4 of the present invention further contains a non aqueous electrolyte.

### [Nonaqueous Electrolyte]

The nonaqueous electrolyte in accordance with an aspect of the present invention is a nonaqueous electrolyte that is typically used in a nonaqueous electrolyte secondary battery and is not limited to a particular one. For example, it is possible to use a nonaqueous electrolyte obtained by dissolving lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄ and the like. The above examples of the lithium salt can be used alone or in combination of two or more kinds. The lithium salt is more preferably at least one kind of fluorine-containing lithium salt, selected from among a group consisting of LiPF₆, LiAsF₆, LiSbF₆, LiBF₄, LiCF₃SO₃, LiN(CF₃SO₂)₂, and LiC(CF₃SO₂)₃ among the above examples of the lithium salt.

Concrete examples of the organic solvent which is a component of the nonaqueous electrolyte in accordance with an aspect of the present invention encompass: carbonates such as ethylene carbonate, propylene carbonate, dimethyl carbonate, diethyl carbonate, ethyl methyl carbonate, 4-trifiuoromethyl-1,3-dioxolane-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolaetone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propanesultone; fluorine-containing organic solvents obtained by introducing a fluorine group into the organic solvent; and the like. The above examples of the organic solvent can be used alone or in combination of two or more kinds. Among the above examples of the organic solvent, the organic solvent is more preferably any of the carbonates, and further preferably a mixed solvent of a cyclic carbonate and a non-cyclic carbonate, or a mixed solvent of a cyclic carbonate and ether. The mixed solvent of a cyclic carbonate and a non-cyclic carbonate is further preferably a mixed solvent containing ethylene carbonate, dimethyl carbonate and ethyl methyl carbonate. This is because the mixed, solvent, containing ethylene carbonate, dimethyl carbonate and ethyl methyl carbonate has a wide operating temperature range and exhibits a persistent property even in a case where a graphite material such as natural graphite or artificial graphite is used as an anode active material.

### [Cathode]

The cathode typically used is a sheet-form cathode in which a cathode mix containing a cathode active material, an electrically conductive material and a binding agent is supported on a cathode current collector.

The cathode active material is, for example, a material which can be doped with lithium ions or dedoped, Concrete examples of such a material encompass lithium composite oxides containing at least one kind of transition metal such as V, Mn, Fe, Co, and Ni. The material is more preferably a lithium composite oxide, such as lithium nickel oxide or lithium cobalt oxide, having an α-NaFeO₂ structure or a lithium composite oxide, such as lithium manganese spinel, having a spinel structure, among the above lithium composite oxides, because these lithium composite oxides have a high average discharge potential. Such a Lithium composite oxide can contain any of various metal elements and further preferably a lithium-nickel composite oxide.

Further, it is still more preferable to use a lithium-nickel composite oxide containing 0.1 mol % to 20 mol % of at least one kind of metal element selected from among a group consisting of Ti, Zr, Ce, Y, V, Cr, Mn, Pe, Go, Cu, Ag, Mg, Al, Ga, In and Sn, in ratio with respect to the sum of the number of moles of the at least one kind of metal element and the number of moles of Ni in nickel-lithium oxide. This is because such a lithium-nickel composite oxide is excellent: in cycle characteristic in a high-capacity use. Among these, it is particularly preferable to employ an active substance which contains Al or Mn and has an Ni-ratio of 85% or higher, further preferably 90% or higher, because a nonaqueous electrolyte secondary battery which includes a cathode containing the active substance is excellent in cycle characteristic in a high-capacity use.

Examples of the electrically conductive material encompass carbonaceous materials such as natural graphite, artificial graphite, cokes, carbon black, pyrolytic carbons, carbon fiber, and a fired body of an organic polymer compound, and the like. The above examples of the electrically conductive material can be used alone or in combination of two or more kinds, for example, as a mixture of artificial graphite and carbon black.

Examples of the binding agent encompass thermoplastic resins such as polyvinylidene fluoride, a vinylidene fluoride copolymer, polytetrafluotoethylene, a vinylidene fluoride-hexafluoroproplene copolymer, a tetrafluoroethylene-hexafluoro propylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resins; and styrene-butadiene rubbers. Note that the binding agent also has a function as a thickening agent.

Examples of the method for obtaining the cathode mix encompass a method in which a cathode mix is obtained by pressing, by pressure, a cathode active material, an electrically conductive material, and a binding agent onto a cathode current collector; a method in which a cathode mix is obtained by preparing a paste of a cathode active material, an electrically conductive material, and a binding agent with the use of an appropriate organic solvent; and the like.

Examples of the cathode current collector encompass electric conductors such as Al, Ni, and stainless steel, it is more preferable to employ Al because Al can be easily formed into a thin film and is inexpensive.

Examples of a method for producing the sheet-form cathode, i.e., a method for causing the cathode current collector to support the cathode mix encompass a method in which a cathode active material, an electrically conductive material, and a binding agent which constitute a cathode mix are formed by pressure; on a cathode current collector; a method in which (i) a cathode mix is obtained from a paste of a cathode active material, an electrically conductive material, and a binding agent which paste has been obtained by the use of an appropriate organic solvent, then (ii) the cathode mix is applied to a cathode current collector, then (iii) a sheet-form cathode mix obtained by drying is pressed by pressure so as to be firmly fixed to the cathode current collector; and the like.

### [Anode]

The anode typically used is a sheet-form anode in which an anode mix containing an anode active material is supported on an anode current collector. The sheet-form anode preferably contains the electrically conductive material and the binding agent.

The anode active material is, for example, a material which can be doped with lithium ions or dedoped, lithium metal, or a lithium alloy. Concrete examples of such a material encompass carbonaceous materials such as natural graphite, artificial graphite, cokes, carbon black, pyrolytic carbons, carbon fiber, and a fired body of an organic polymer compound; chalcogen compounds such as an oxide and a sulfide which can be doped with lithium ions or dedoped at an electric potential lower than that of the cathode; metal such as aluminum (Al), lead (Pb), tin (Sn), bismuth (Bi), or silicon (Si) which is alloyed with alkali metal; an intermetallic compound (AlSb, Mg₂Si, NiSi₂) of a cubic system in which intermetallic compound alkali metal can be inserted in voids in a lattice; a lithium nitrogen compound [Li₃-xMₓN (M: transition metal)]; and the like. Among the above anode active materials, it is more preferable to employ a carbonaceous material which contains a graphite material such as natural graphite or artificial graphite as a main component, because great, energy density can be obtained, due to superior potential flatness and low average discharge potential, in a case where the carbonaceous material is combined, with the cathode. Alternatively, the anode active material can be a mixture of graphite and silicon. In such a case, it is preferable to employ an anode active material in which a ratio of Si relative to carbon (C) constituting graphite is 5% or higher, and it is more preferable to employ an anode active material in which the ratio of SI relative to carbon (G) constituting graphite is 10% or higher.

Examples of a method for obtaining the anode mix encompass a method in which an anode mix is obtained by pressing an anode active material onto an anode current collector by pressure; a method in which an anode mix is obtained by preparing a paste of an anode active material with the use of an appropriate organic solvent; and the like.

Examples of the anode current collector encompass Cu, Ni, stainless steel, and the like. In particular, it is more preferable to employ Cu because Cu hardly forms an alloy with lithium in the lithium-ion secondary battery and Cu can be easily formed into a thin film.

Examples of a method for producing the sheet-form, anode, i.e., a method for causing the anode current collector to support the anode mix encompass a method in which an anode active material which constitutes an anode mix is formed by pressure on an anode current collector; a method in which (i) an anode mix is obtained from a paste of an anode active material which paste has been obtained by the use of an appropriate organic solvent, then (ii) the anode mix is applied to an anode current collector, and then (iii) a sheet-form anode mix obtained by drying is pressed by pressure so as to be firmly fixed to the anode current collector; and the like. The paste preferably contains the electrically conductive material and the binding agent.

A method for producing the nonaqueous electrolyte secondary battery member in accordance with an aspect of the present invention can be, for example, a method in which the cathode, the porous film or the laminated body, and the anode are arranged in this order. The nonaqueous electrolyte secondary battery in accordance with an aspect of the present invention can be produced by, for example, (i) forming a nonaqueous electrolyte secondary battery member by the above method, then (ii) putting the member for the nonaqueous electrolyte secondary battery into a container that serves as a housing of the nonaqueous electrolyte secondary battery, then (iii) filling the container with a nonaqueous electrolyte, and then (iv) sealing the container while reducing pressure. A shape of the nonaqueous electrolyte secondary battery is not limited to a particular one. The shape of the nonaqueous electrolyte secondary battery can be any of shapes such as a thin plate (paper) shape, a disc-like shape, a cylindrical shape, and a prismatic shape such as a rectangular parallelepiped. Note that methods for producing the nonaqueous electrolyte secondary battery member and the nonaqueous electrolyte secondary battery are not limited to particular ones and conventionally known production methods can be employed.

The nonaqueous electrolyte secondary battery member in accordance with an aspect of the present invention and the nonaqueous electrolyte secondary battery in accordance with an aspect of the present invention include, as a separator or a separator base material, a porous film whose tensile creep compliance in a specific time falls within a specific range. Therefore, a nonaqueous electrolyte secondary battery including the nonaqueous electrolyte secondary battery member of the present invention and the nonaqueous electrolyte secondary battery of the present invention are excellent in rate characteristic because decrease in rate characteristic is restricted in a ease of fast charging and discharging.

The present invention is not limited to the embodiments, but can be altered by a skilled person in the art within the scope of the claims. An embodiment derived from a proper combination of technical means each disclosed in a different, embodiment is also encompassed in the technical scope of the present invention. Further, it is possible to form a new technical feature by combining the technical means disclosed in the respective embodiments.

### EXAMPLES

The present invention will be described further in detail with reference to Examples and Comparative Examples below. Note, however, that the present invention is not limited to these Examples.

### [Measurement]

In Examples and Comparative Examples below, (i) a melt, flow rate (MFR) of a polyolefin resin composition, (ii) a thickness, a porosity, and a tensile creep compliance (J(t)) of a nonaqueous electrolyte secondary battery separator, and (iii) a rate characteristic (20 C./0.2 C.) of a nonaqueous electrolyte secondary battery were measured.

(a) Thickness (unit: μm)

A thickness of a porous film which, was each of nonaqueous electrolyte secondary battery separators produced in respective of Examples and Comparative Examples was measured in accordance with the JIS standard (K 7130-1992) with use of a high-precision digital length measuring machine manufactured by Mitutoyo Corporation.

(b) Porosity (unit: volume %)

A porosity of a porous film which was each of nonaqueous electrolyte secondary battery separators produced in respective of Examples and Comparative Examples was measured with a method described below:
(i) A produced porous film was cut out in a square shape of 10 cm×10 cm, and a weight; W (g) of a small piece thus cut out was measured.
(ii) A unit of the thickness of the porous film measured in (a) was changed to “cm”, and defined as E (cm),
(iii) The small piece whose weight was measured in (i) was crushed into fine powder. The powder was put into a container and compressed, and then a volume; V (cm³) of the powder was measured. In accordance with a formula (1) below, a real density: ρ (g/cm³) of a resin composition constituting the porous film was calculated from the volume: V (cm³) and the weight: W (g) of the fine powder.

Real density ρ (g/cm³)=W (g)/V (cm³) (1)
(iv) In accordance with a formula (2) below, a porosity (volume %) was calculated from the weight: W (g), the thickness: E (cm), and the real density: ρ (g/cm³) which were measured or calculated in the above (i) through (iii).

Porosity (volume %)=[1−{(W/ρ)}/(10×10×E)]×100 (2)

(c) Tensile Creep Compliance (J(t)) (unit: GPa⁻¹)

A tensile creep compliance J (t) was calculated by measuring a “tensile creep elastic modulus” in a specific time (t) based on JIS K 7115 under conditions in which a temperature was 23° C., a relative humidity was 50%, and a stress applied to the porous film in the transverse direction was 30 MPa, and obtaining a reciprocal number of the “tensile creep elastic modulus”. Note that, with regard to the time t, the value; J of the tensile creep compliance was measured every second in a range from 1 second to 3600 seconds.

(d) Melt Flow Rate (MPR; (unit: g/10 min)

Under the following measurement conditions, a melt flow rate (MFR) of a poly olefin resin composition in each of Examples and Comparative Examples was measure in conformity to JIS K 7120-1.

### Measurement Conditions:

Orifice: diameter of 3 mm×length of 10 mm
Measurement temperature: 240° C.
Load: 21.6 kg.

### (e) Rate Characteristic (%)

A new nonaqueous electrolyte secondary battery which was produced in each of Examples and Comparative Examples and did not undergo a charge-discharge cycle was subjected to four cycles of initial charge and discharge, each of the four cycles included a voltage range of 4.1 V to 2.7 V and an electric current of 0.2 C. (where 1 C. is an electric current at which a rated capacity with a discharge capacity at one hour rate is discharged for one hour; the same applies to the descriptions below) at 25° C.

After the initial charge and discharge, the nonaqueous electrolyte secondary battery was subjected to three cycles of charge and discharge with use of a constant current whose charging current was 1 C. and discharging current was 0.2 C. at 55° C., and further the nonaqueous electrolyte secondary battery was subjected to three cycles of charge and discharge with use of a constant current of 20 C. Thus, a discharge capacity in each of the cases was measured.

The discharge capacities at respective discharging currents of 0.2 C and 20 C at the third cycle were used as measurement values of discharge capacity. Subsequently, with use of the discharge capacity thus measured at the discharging current of 0.2 C and the discharge capacity thus measured at the discharging current of 20 C, a rate characteristic was obtained based on a formula (3) below:

Rate characteristic (%)=(discharge capacity at 20 C/discharge capacity at 0.2 C)×100 (3)

### Example 1

### <Production of Nonaqueous Electrolyte Secondary Battery Separator>

First, 70% by weight of ultra-high molecular weight polyethylene powder (GUR4032, manufactured by Tieona GmbH) and 30% by weight of polyethylene wax (FMP-0115, manufactured by Nippon Seiro Co., Ltd.) having a weight-average molecular weight of 1000 were mixed, and then 0.4% by weight of an antioxidant (Lrg1010, manufactured by Ciba Specialty Chemicals, Inc), 0.1% by weight of an antioxidant (P168, manufactured by Ciba Specialty Chemicals, Inc.), and 1.3% by weight of sodium stearate were added to 100 parts by weight of a mixture of the ultra-high molecular weight polyethylene and the polyethylene wax. Further, 36 volume % of calcium carbonate (manufactured by Maruo Calcium Co., Ltd.) having an average pore diameter of 0.1 μm was added, relative to a total volume. Then, these compounds were mixed in a form of powder with a Hensehel mixer, and thus a mixture 1 was obtained. Subsequently, the mixture 1 was melted and kneaded with a twin screw kneading extruder, and thus a polyolefin resin composition 1 was obtained. A melt flow rate (MFR) of the polyolefin resin composition 1 was 35 g/10 min. The polyolefin resin composition 1 was rolled with a pair of rollers having a surface temperature of 150° C., and thus a rolled sheet 1 was prepared. Subsequently, the rolled sheet 1 was soaked in a hydrochloric acid solution (4 mol/L of hydrochloric acid, 0.5% by weight of nonionic surfactant) so that calcium carbonate was removed from, the rolled sheet 1, then the roiled sheet 1 was stretched to 6.2 times in a transverse direction at 105° C., and was further subjected to heat fixation at 120° C. by a tenter. Thus, a porous film 1 was obtained. The porous film 1 served as a nonaqueous electrolyte secondary battery separator 1.

### <Preparation of Nonaqueous Electrolyte Secondary Battery>

### (Preparation of Cathode)

A commercially available cathode was used which had been produced by applying LiNi_{0.5}Mn_{0.3}Co_{0.2}O₂/electrically conductive material/PVDF (weight ratio of 92/5/3) to an aluminum foil. The aluminum foil was cut out so that (i) a part, on which the cathode active material layer was formed had a size of 40 mm×35 mm and (ii) a part remained (a) which surrounded the part on which the cathode active material layer was formed, (b) which had a width of 13 mm, and (c) on which no cathode active material layer was formed, and thus a cathode was obtained. The cathode active material layer had a thickness of 58 μm and a density of 2.50 g/cm³.

### (Preparation of Anode)

A commercially available anode was used which had been, produced by applying graphite/styrene-1,3-butadiene copolymer/sodium carboxy methyl cellulose (weight ratio of 98/1/1) to a copper foil. The copper foil was cut out so that (i) a part on which the anode active material layer was formed had a size of 50 mm×40 mm and (ii) a part, remained, (a) which surrounded the part on which the anode active material layer was formed, (b) which had a width of 13 mm, and (c) on which no anode active material layer was formed, and thus an anode was obtained. The anode active material layer had a thickness of 49 μm and a density of 1.40 g/cm³.

### (Production of Nonaqueous Electrolyte Secondary Battery)

A nonaqueous electrolyte secondary battery member 1 was obtained by laminating (arranging), in a lamination pouch, the cathode, the porous film 1 (electrolyte secondary battery separator 1), and the anode in this order. In this case, the cathode and the anode were arranged such that an entire main surface of the cathode active material layer of the cathode is included in (overlaps with) a range of a main surface of the anode active material layer of the anode.

Then, the member for the nonaqueous electrolyte secondary battery 1 was put into a bag formed, in advance, by laminating an aluminum layer and a heat sealing layer, and further 0.25 ml of a nonaqueous electrolyte was put into the bag. The nonaqueous electrolyte was prepared by dissolving 1 mol/L of LiPF₆, in a mixed solvent in which ethylene carbonate, ethyl methyl carbonate, and diethyl carbonate were mixed at 3:5:2 (volume ratio). Then, a nonaqueous electrolyte secondary battery 1 was prepared by heat sealing the bag while reducing pressure in the bag.

### Example 2

A porous film 2 was obtained in a manner similar to that of Example 1, except that the heat fixation temperature was changed to 115° C. The porous film 2 served as a nonaqueous electrolyte secondary battery separator 2.

A nonaqueous electrolyte secondary battery 2 was prepared in a manner similar to that of Example 1, except that the porous film 2 was used instead of the porous film 1.

### Comparative Example 1

First, 68% by weight of ultra-high molecular weight polyethylene powder (GUR2024, manufactured by Ticona GmbH) and 32% by weight of polyethylene wax (FNP-0115, manufactured by Nippon Seiro Co., Ltd.) having a weight-average molecular weight of 1000 were mixed, and then 0.4% by weight of an antioxidant (Irg1010, manufactured by Ciba Specialty Chemicals, Inc.), 0.1% by weight of an antioxidant (P168, manufactured by Ciba. Specialty Chemicals, Inc), and 1.3% by weight, of sodium stearate were added to 100 parts by weight of a mixture of the ultra-high molecular weight, polyethylene and the polyethylene wax. Further, 33 volume % of calcium carbonate (manufactured by Marco Calcium Co., Ltd.) having an average pore diameter of 0.1 μm was added relative to a total volume. Then, these compounds were mixed in a form of powder with a Henschel mixer, and thus a mixture 3 was obtained. Subsequently, the mixture 3 was melted and kneaded with a twin screw kneading extruder, and thus a poly olefin resin composition 3 was obtained. A melt flow rate (MFR) of the polyolefin resin composition 3 was 15 g/10 min. The polyolefin resin composition 3 was rolled with a pair of rollers having a surface temperature of 150° C., and thus a rolled sheet 3 was prepared. Subsequently, the rolled sheet 3 was soaked in a hydrochloric acid solution (4 mol/L of hydrochloric acid, 0.5% by weight of nonionic surfactant) so that calcium carbonate was removed from the rolled sheet 3, then the rolled sheet 3 was stretched to 6.2 times in a transverse direction at 100° C., and was further subjected to heat fixation at 126° C. by a tenter. Thus, a porous film 3 was obtained. The porous film 3 served as a nonaqueous electrolyte secondary battery separator 3.

A nonaqueous electrolyte secondary battery 3 was prepared in a manner similar to that of Example 1, except that the porous film 3 was used instead of the porous film 1.

### [Comparative Example 2]

First, 71.5% by weight of ultra-high molecular weight polyethylene powder (GUR4032, manufactured by Ticona GmbH) and 28.5% by weight of polyethylene wax (FNP-0115, manufactured by Nippon Seiro Co., Ltd.) having a weight-average molecular weight of 1.000 were mixed, and then 0.4% by weight of an antioxidant (Irg1010, manufactured by Ciba Specialty Chemicals, Inc.), 0.1% by weight of an antioxidant (PI 63, manufactured by Ciba Specialty Chemicals, Inc), and 1.3% by weight of sodium stearate were added to 100 parts by weight of a mixture of the ultra-high molecular weight polyethylene and the polyethylene wax. Further, 37 volume % of calcium carbonate (manufactured by Maruo Calcium Co., Ltd,) having an average pore diameter of 0.1 μm was added relative to a total volume. Then, these compounds were mixed in a form of powder with a Henschel mixer, and thus a mixture 4 was obtained. Subsequently, the mixture 4 was melted and kneaded with a twin screw kneading extruder, and thus a polyolefin resin composition 4 was obtained. A melt flow rate (MFR) of the polyolefin resin composition 4 was 30 g/10 min. The polyolefin resin composition 4 was rolled with a pair of rollers having a surface temperature of 150°, and thus a rolled sheet 4 was prepared. Subsequently, the rolled sheet 4 was soaked in a hydrochloric acid solution (4 mol/L of hydrochloric acid, 0.5% by weight of nonionic surfactant) so that calcium carbonate was removed from the rolled sheet 4, then the rolled sheet 4 was stretched to 7.0 times in a transverse direction at 100° C., arid was further subjected to heat fixation at 123° by a tenter. Thus, a porous film 4 was obtained. The porous film 4 served as a nonaqueous electrolyte secondary battery separator 4.

A nonaqueous electrolyte secondary battery 4 was prepared in a manner similar to that of Example 1, except that the porous film 4 was used instead of the porous film 1.

### [Measurement Result]

The “thickness”, the “porosity”, and the “tensile creep compliance” of each of the nonaqueous electrolyte secondary battery separators 1 through 4 obtained in Examples 1 and 2and Comparative Examples 1 and 2, respectively, were measured with the foregoing methods. Moreover, Table 1 shows values of tensile creep compliance in eases where t=300 seconds, t=1800 seconds, and t=3600 seconds,

TABLE 1

| | Tensile creep compliance (GPa⁻¹) in time t (sec) | | |
|---|---|---|---|
| | t = 300 sec | t = 1800 sec | t = 3600 sec |
| Example 1 | 5.4 | 10.6 | 14.5 |
| Example 2 | 8.8 | 18.8 | 24.2 |
| Comparative | 3.6 | 6.6 | 8.5 |
| Example 1 | | | |
| Comparative | 4.0 | 6.8 | 8.3 |
| Example 2 | | | |

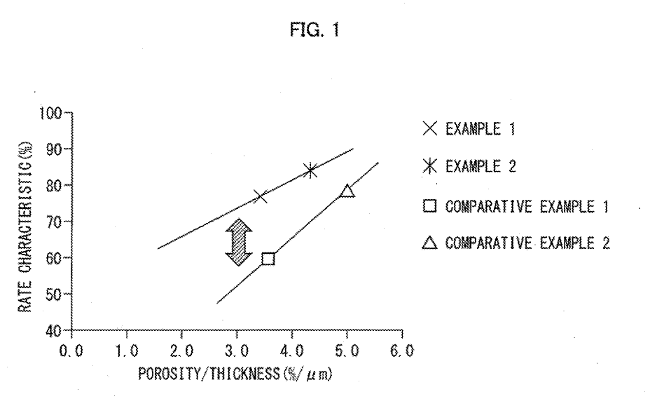

Moreover, the “rate characteristic” of each of the nonaqueous electrolyte secondary batteries 1 through 4 obtained in Examples 1 and 2 and Comparative Examples 1and 2, respectively, was measured with the foregoing method. Table 2 shows measurement results of the “thickness”, the “porosity”, and the “rate characteristic”. Moreover, FIG. 1 shows a relation between the “rate characteristic” and the “porosity/thickness”.

TABLE 2

| | Physical properties of nonaqueous | | | |
|---|---|---|---|---|
| | electrolyte secondary battery separator | | | |
| | | | Porosity/ | Rate |
| | Thickness | Porosity | thickness | characteristic |
| | (μm) | (volume %) | (volume %/μm) | (%) |
| Example 1 | 15.4 | 53 | 3.4 | 77 |
| Example 2 | 15.0 | 65 | 4.3 | 84 |
| Comparative | 10.4 | 37 | 3.6 | 60 |
| Example 1 | | | | |
| Comparative | 10.1 | 50 | 5.0 | 78 |
| Example 2 | | | | |

### [Conclusion]

From the results shown in Table 1, it was found that the nonaqueous electrolyte secondary battery separators prepared in Examples 1 and 2 had greater tensile creep compliances (J) in the same time t, as compared with the nonaqueous electrolyte secondary battery separators prepared in Comparative Examples 1 and 2, and the nonaqueous electrolyte secondary battery separators prepared in Examples 1 and 2 satisfied at least one of conditions (i) through (iii) below;

(i) when t=300 seconds, J is 4.5 GPa⁻¹ to 14.0 GPa⁻¹,

(ii) when t=1800 seconds, J is 9.0 GPa⁻¹ to 25.0 GPa⁻¹,

(iii) when t=3600 seconds, J is 12.0 GPa⁻¹ to 32.0 GPa⁻¹.

Moreover, it is generally known that a rate characteristic of a nonaqueous electrolyte secondary battery depends on a value of porosity/thickness of a separator, From the descriptions in Table 2 and FIG. 1, the followings have been found: that is, when Example 1 and Comparative Example 1 having substantially identical values of porosity/thickness of the separators are compared and Example 2 and Comparative Example 2 having substantially identical values of porosity/thickness of the separators are compared, the nonaqueous electrolyte secondary batteries prepared in Examples 1 and 2 have higher rate characteristics.

From the above results, it is shown that the nonaqueous electrolyte secondary battery in which the nonaqueous electrolyte secondary battery separator satisfying at least one of the conditions (i) through (iii) is used is excellent in rate characteristic.

### INDUSTRIAL APPLICABILITY

The nonaqueous electrolyte secondary battery separator and the nonaqueous electrolyte secondary battery laminated separator of the present invention can be suitably used to produce a nonaqueous electrolyte secondary battery that is excellent in rate characteristic.

1. A nonaqueous electrolyte secondary battery separator comprising a porous film which contains a poly olefin resin as a main component,
the porous film having a tensile creep compliance J that satisfies at least one of conditions (i) through (iii) below in a case where stress of 30 MPa is applied for t seconds in a transverse direction:
(i) when t=300 seconds, J is 4.5 GPa⁻¹ or more and 14.0 GPa⁻¹ or less.
(ii) when t=1800 seconds, J is 9.0 GPa⁻¹ or more and 25.0 GPa⁻¹
or less,
(iii) when t=3600 seconds, J is 12.0 GPa⁻¹ or more and 32.0 GPa⁻¹
or less.

2. The nonaqueous electrolyte secondary battery separator as set forth in claim 1, wherein said nonaqueous electrolyte secondary battery separator satisfies ail the conditions (i) through (iii).

3. A nonaqueous electrolyte secondary battery laminated separator comprising:
a nonaqueous electrolyte secondary battery separator recited in claim 1; and
a porous layer which is laminated on at least one surface of the nonaqueous electrolyte secondary battery separator.

4. A nonaqueous electrolyte secondary battery member, comprising:
a cathode;
a nonaqueous electrolyte secondary battery separator recited, in claim 1; and
an anode,
the cathode, the nonaqueous electrolyte secondary battery separator, and the anode being arranged in this order.

5. A nonaqueous electrolyte secondary battery member, comprising:
a cathode;
a nonaqueous electrolyte secondary battery laminated separator recited in claim 3; and
an anode,
the cathode, the nonaqueous electrolyte secondary battery laminated separator, and the anode being arranged in this order.

6. A nonaqueous electrolyte secondary battery comprising a nonaqueous electrolyte secondary battery separator recited in claim 1.

7. A nonaqueous electrolyte secondary battery comprising a nonaqueous electrolyte secondary battery laminated separator recited in claim 3.
